(19) United States
(12) Patent Application Publication
(10) Pub. No.: US 2003/0152112 A1
(43) Pub. Date: Aug. 14, 2003

(54) Inverse multiplexing via disparate links

(75) Inventors: Ariel Almog, Kocav Yair (IL); Zeev Oster, Modiin (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: SPEDIANT SYSTEMS LTD.

(21) Appl. No.: 10/335,872

(22) Filed: Jan. 3, 2003

Related U.S. Application Data
(60) Provisional application No. 60/352,255, filed on Jan. 30, 2002.

(51) Int. Cl. H04J 3/04

(52) U.S. Cl. 370/535

(57) ABSTRACT

An inverse multiplexing method for transmitting data via multiple data links by apportioning the symbols to be transmitted among the available communication links in proportion to the individual communication links' symbol transmission rates in a predictable manner, and a system, including a transmitter and a receiver, employing this method. Preferably, a table shared by the transmitter and receiver is used by the transmitter to apportion the symbols to the various communication links and by the receiver to reconstruct the original data. The method allows fine granularity in the division of symbols, which in turn allows for short messages to be transmitted at high speed, and with minimal latency, by using the full capacity of the communication links, with a minimum of overhead.

### FIELD AND BACKGROUND OF THE INVENTION

The present invention relates to a system for inverse multiplexing data streams via multiple links, and more particularly to a system that divides the data transmission load among links that may not all have the same symbol rate capacity, in such a way as to maximize data throughput and minimize data latency.

In an inverse multiplexing system, multiple data links are joined together in parallel to form a single aggregate link whose total data transmission capacity is close to or equal to the sum of the data transmission capacities of the individual links.

At the transmitter, an inverse multiplexing system must divide the data stream into separate data streams, one for each of the links being used, while the receiver must recombine the several streams to recover the original data stream.

Several protocols for inverse multiplexing exist, including IMA (ATM), MLFR (Frame Relay) and MP (Network working group), which handle the transmission of ATM cells or packets from a single source to a single destination via multiple links.

Each of the existing inverse multiplexing protocols described above suffers from disadvantages when applied to links with variable bit rates, such as xDSL links, and is well-suited to some types of link configurations, but less so for others.

Disadvantages of existing inverse multiplexing protocols include:

Data unit overhead for headers and trailers—existing protocols place headers, and sometimes trailers, on each data packet. For example, an ATM cell contains 10.4% overhead, and in the ML protocol the PPP header, FCS trailer and MP header cost 8 or 10 bytes of overhead per fragment. In general, small data units, such as those used in IMA, have greater overhead relative to the quantity of user data transmitted.

Management overhead—to keep track of the several data streams so they can be reassembled properly at the receiver, inverse multiplexing schemes transmit management data along with user data. For example, in the ATM IMA protocol an IMA Control Protocol (ICP) cell should be sent via each link every M cells, where M can be 32, 64, 128, or 256. The overhead thus introduced is therefore between 0.4% (M=256) and 3.1% (M=32).

Difficulty supporting more than one data type—existing inverse multiplexing protocols allow for only a single type of protocol passing through the aggregate link. Therefore, supporting a real-time data stream, such as TDM, and a non-real-time stream, such as a file transfer, on the same aggregate link may cause latency in the real-time stream, or severe fragmentation of the non-real-time stream.

Latency—existing inverse multiplexing protocols support the transfer of data on each link in packets of at least some minimum size. This adds to latency, and unpredictability of latency, for real-time streams, as data may wait in a buffer until enough bytes for a full packet are ready. Alternatively, short, time-sensitive data items can be sent in truncated or padded packets, but this is wasteful of bandwidth.

Lack of support for links with different data rates—many different types of links, such as xDSL or analog fax-modems, whose data rates may vary, depending upon such factors as link length, type of technology, and electromagnetic noise, and with varying latencies, may be available for use in the aggregate link. Existing protocols do not adequately provide for the efficient distribution of the data load among links that do not all have the same data rate and latency. Additionally, existing protocols do not adequately support the use of links having asymmetric data rates, such as ADSL, in aggregate links.

Lack of support for high-speed protection switching—an important deficiency of some existing inverse multiplexing protocols is an inadequate ability to perform fast protection switching in the event of a failure of one or more of the links. By providing spare links, the inverse multiplexing mechanism can switch traffic from faulty links to spare links, and switch the traffic back to the regular links when the regular links become available again, all without serious disruption of data flow. Alternatively, the system can make use of all available links under normal conditions, and continue operating, but at reduced aggregate throughput in the event of failure of one or more links. If the data being carried by the aggregate link consists of a mixture of data of varying priorities or varying sensitivity to delay, low-priority data can be dropped and/or delay-insensitive data can be deferred during periods of link outage.

There is thus a widely recognized need for, and it would be highly advantageous to have, a system for inverse multiplexing data streams via multiple links that can reduce fragmentation overhead, data unit overhead, and management data overhead, support more than one data type via a single aggregate link, reduce data latency, efficiently utilize links of various data rates in a single aggregate link, and provide for high-speed protection switching.

### SUMMARY OF THE INVENTION

According to the present invention there is provided a system for transmitting symbols via a plurality of communication links, each communication link having a respective link symbol transmission rate, the system including: (a) a transmitter including: (i) an input port operative to receive symbols; (ii) a plurality of output ports operative to present the symbols to respective communication links; and (iii) a mechanism for indicating when to transmit symbols for each respective link symbol transmission rate.

Preferably, the transmitter includes a table of rows of flags indicating when to transmit symbols, each row corresponding to one of the link symbol transmission rates.

Preferably, a respective number of the flags in each row are set, the number chosen such that symbols are transmitted via corresponding output ports at a rate at most equal to the corresponding link symbol transmission rate.

Preferably, a respective number of the flags in each row are set, the number chosen such that symbols are transmitted via corresponding output ports at a rate substantially proportional to the corresponding link symbol transmission rate.

Preferably, the transmitter further includes: (iv) at least one buffer operative to store, in a first-in-first-out fashion, symbols waiting to be transmitted via the communication links.

Preferably, the system further includes: (b) a receiver, for receiving symbols via the communication links, the receiver including a mechanism for providing indications of when symbols are scheduled to be transmitted for each respective link symbol transmission rate.

Preferably, the receiver further includes at least one buffer operative to store, in a first-in-first-out fashion, symbols arriving via the communication links.

According to the present invention there is provided a method for transmitting symbols via a plurality of communication links, each communication link having a respective link symbol transmission rate, the method including the steps of: (a) indicating when to transmit symbols for each respective link symbol transmission rate; and (b) for each symbol, selecting a communication link to transmit the symbol, according to the indications of when to transmit symbols.

Preferably, the indicating of when to transmit symbols includes providing a table of rows of flags indicating when to transmit symbols, each row corresponding to one of the link symbol transmission rates.

The present invention successfully addresses the shortcomings of the presently known inverse multiplexing systems by dividing the symbols to be transmitted among the available communication links in proportion to the individual communication links' symbol transmission rates in a predictable manner, allowing fine granularity in the division of symbols, which in turn allows for short messages to be transmitted at high speed, and with minimal latency, using the full capacity of a plurality of communication links, with a minimum of overhead.

### BRIEF DESCRIPTION OF THE DRAWINGS

The invention is herein described, by way of example only, with reference to the accompanying drawings, wherein:

FIG. 1 is a schematic illustration of an inverse multiplex communication system according to the present invention;

FIG. 2 is a schematic illustration of the transmission and reception of a sample message using an inverse multiplex communication system according to the present invention.

### DESCRIPTION OF THE PREFERRED EMBODIMENTS

The present invention is of an inverse multiplexing system that can be used to transmit a single data stream via multiple links, making optimal use of the available transmission capacity.

The principles and operation of an inverse multiplexing system according to the present invention may be better understood with reference to the drawings and the accompanying description.

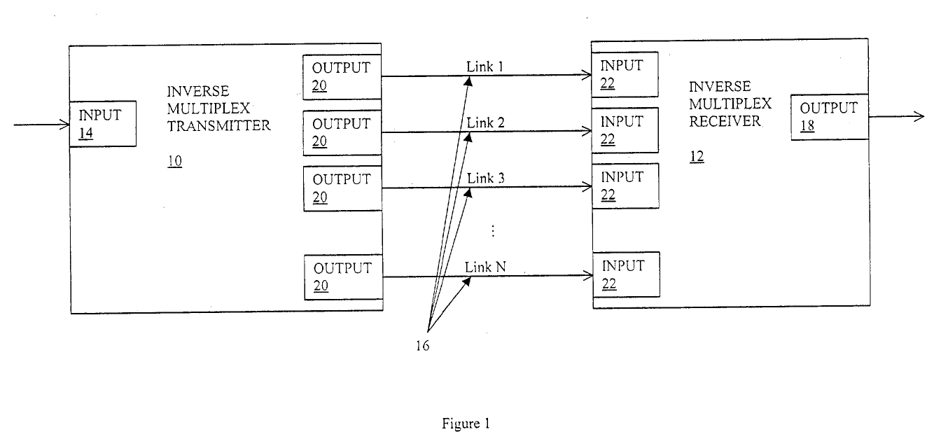

Referring now to the drawings, FIG. 1 illustrates an inverse multiplexing system according to the present invention. A stream of symbols is presented to an inverse multiplex transmitter 10 by means of a transmitter input port 14. Inverse multiplex transmitter 10 apportions, in a manner described below, incoming symbols among a plurality of transmitter output ports 20 operative to send these symbols via corresponding links 16. Receiver input ports 22 of an inverse multiplex receiver 12 accept symbols from links 16 and inverse multiplex receiver 12 reassembles these symbols, as described below, and presents the reassembled symbol stream to a receiver output port 18.

The present invention takes advantage of the available bandwidth of links 16 by having inverse multiplex transmitter 10 allocate transmission of the individual symbols of the symbol stream among links 16 in a predictable manner. Since the symbols are transmitted via links 16 in a predictable manner, inverse multiplex receiver 12 is able to reassemble the original symbol stream, without the need to embed sequencing data in the symbol stream. This allows even very short messages to take advantage of the multiple links 16 with little overhead.

In a system where individual links 16 do not all have the same symbol transmission rate, it is not efficient simply to divide the symbols of the input symbol stream on a round-robin basis, i.e., in a system with N transmitter output ports 20 operative to sent symbols via N corresponding links 16, send the first symbol to the first link 16 via the first transmitter output port 20, send the second symbol to the second link 16 via the second transmitter output port 20, etc., with the Nth symbol going to the Nth link 16 via the Nth transmitter output port 20, the N+1th symbol going to the first link 16 via the first transmitter output port 20, and so on. Such a round-robin distribution would tend to overrun the data transmission capacities of the slower links 16, while the faster links 16 might remain idle for a substantial portion of the time.

One preferred embodiment of the present invention overcomes this problem by maintaining a table of symbol transmission flags for links of various link symbol transmission rates, a particular example of which is illustrated in Table 1, which follows:

TABLE 1

| Row | Multiple of | Symbol transmission group: | | | | |
|---|---|---|---|---|---|---|
| number: | base rate: | 1 | 2 | 3 | 4 | 5 |
| 0 | 1 | Y | | | | |
| 1 | 2 | Y | | Y | | |
| 2 | 5 | Y | Y | Y | Y | Y |

Table 1 contains a row for each symbol transmission rate of the links 16 the system uses. Each row contains a sequence of flags, the flags indicating whether a symbol should be transmitted via this link 16 in the corresponding symbol transmission group, as explained below. In Table 1, for illustrative purposes, “Y” has been used for flags indicating transmission, and blank space for flags not indicating transmission, but any combination of distinct symbols may be used.

This preferred embodiment of transmitter 10 uses a second table, a particular example of which is illustrated in Table 2, which follows:

TABLE 2

| Link | Multiple of | Row of Symbol Group |
|---|---|---|
| number: | base rate: | table to use: |
| 1 | 1 | 0 |
| 2 | 2 | 1 |
| 3 | 5 | 2 |
| 4 | 2 | 1 |

This second table includes a row for each link 16 in the system, each row including an indication of the symbol transmission rate of that link 16, which is used to find the row of the first table to use with this link 16.

In operation, this preferred embodiment of the present invention uses a third table, a particular example of which is illustrated in Table 3, which follows:

TABLE 3

| Link | Multiple of | Symbol transmission group: | | | | |
|---|---|---|---|---|---|---|
| number: | base rate: | 1 | 2 | 3 | 4 | 5 |
| 1 | 1 | Y | | | | |
| 2 | 2 | Y | | Y | | |
| 3 | 5 | Y | Y | Y | Y | Y |
| 4 | 2 | Y | | Y | | |

Table 3 combines the data of Table 1 and Table 2 so that each link 16 has a row of symbol transmission flags. Although this preferred embodiment might require more memory than an embodiment wherein Table 2 is used to index Table 1, the use of Table 3 allows the transmission algorithm to be simpler and faster. While this preferred embodiment is used here for illustrative purposes, the scope of the present invention also includes other embodiments that do not include this third table. The transmitter sends symbols via links 16 in symbol transmission groups. For each group, transmitter 10 traverses, in a predetermined order, the symbol transmission flags of each link 16 for that group. If transmitter 10 encounters a set flag, the next symbol of the input symbol stream is transmitted via the corresponding link 16 via the corresponding transmitter output port 20 and transmitter 10 continues traversing the symbol transmission flags of that group. If transmitter 10 encounters a flag that is not set, then transmitter 10 continues traversing the symbol transmission flags of that group. When transmitter 10 has traversed all of the flags of a symbol transmission group, transmitter 10 begins to traverse the next symbol transmission group. When transmitter 10 has traversed all of the symbol transmission groups, transmitter 10 continues with the first symbol transmission group, in a cyclic fashion.

Transmitter 10 sends data via the several links 16, via corresponding transmitter output ports 20, the several links 16 substantially simultaneously transmitting the data to receiver 12. This substantially simultaneous transmission allows the system to take full advantage of the available links 16. This substantially simultaneous transmission is facilitated by buffering the transmitted symbols in a first-in-first-out fashion. Since the various links 16 have different link symbol transmission rates, and different data link latencies, which may vary over time, the buffering requirements for individual links 16 vary. Faster links 16, and links 16 with large variations in data link latencies may require larger buffers.

Referring again to FIG. 1, inverse multiplex receiver 12 in this preferred embodiment of the present invention makes use of the same tables as inverse multiplex transmitter 10.

Inverse multiplex receiver 12 accepts symbols from links 16 via receiver input ports 22 in an order determined by Table 3, as described below.

Receiver 12 traverses each symbol transmission group in the same order as transmitter 10 traverses each symbol transmission group. If receiver 12 encounters a set flag, receiver 12 waits for a symbol from the corresponding link 16 to arrive at the corresponding receiver input port 22, presents that symbol to receiver output port 18, and continues traversing the symbol transmission flags of that group. If receiver 12 encounters a flag that is not set, receiver 12 continues traversing the symbol transmission flags of that group. When receiver 12 has traversed all of the flags of a symbol transmission group, receiver 12 begins to traverse the next symbol transmission group. When receiver 12 has traversed all of the symbol transmission groups, receiver 12 continues with the first symbol transmission group, in a cyclic fashion. Since links 16 are independent and may have different characteristics and link symbol transmission rates, it is necessary to buffer, in a first-in-first-out fashion, symbols arriving at inverse multiplex receiver 12, so that symbols arriving via fast links 16 may be held while waiting for symbols that are prior to these symbols in the data stream, but arriving via slower links 16.

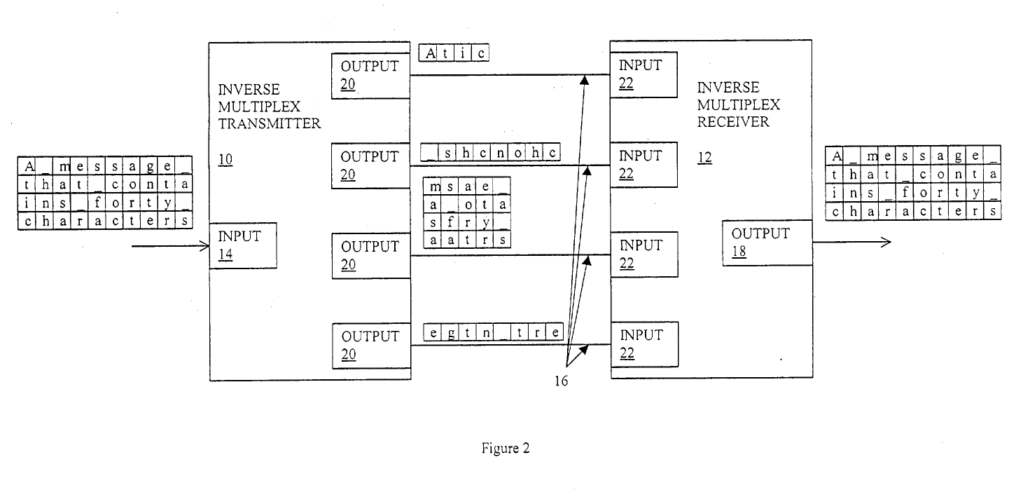

The operation of this preferred embodiment of the present invention may be better understood by considering the example illustrated in FIG. 2. FIG. 2 shows schematically the way the present invention transmits the illustrative message “A_message_that_contains_forty_characters”. In this illustrative case, there are four links 16, the first link 16 having an arbitrary link symbol transmission rate, and the second, third and fourth links 16 having respective symbol transmission rates of two, five, and two times the link symbol transmission rate of the first link 16. Respective links 16 provide transmission pathways between corresponding transmitter output ports 20 of transmitter 10 and corresponding receiver input ports 22 of receiver 12. In this illustration, a symbol is a single letter or character, such as “a” or “_”, and use is made of Table 3.

In the first symbol transmission group, every flag is set, so the four links 16 carry the symbols “A”, “_”, “m”, and “e”, respectively. In the next symbol transmission group, only the third flag, that of the high-speed third link 16, is set, so the symbol “s” is sent to the third link 16, while the other links 16 continue sending their previous symbols. In the third transmission group, transmitter 10 finds the second, third and fourth flags set, so transmitter 10 sends the symbol “s” via the second link 16, the symbol “a” via the third link 16, and the symbol “g” via the fourth link 16. Note that the first link 16 is still in the process of transmitting the symbol “A”, and that the second and fourth links 16 must either buffer, in a first-in-first-out fashion, their new symbols, “s” and “g”, respectively, until they finish sending their old symbols, “_” and “e”, respectively, or, alternatively, transmitter 10 delays sending the new symbols until the old symbols have been transmitted, in which case there is a small reduction in the aggregate link symbol transmission rate, and some skewing of symbol transmission times is introduced, which must be accommodated by buffering in receiver 12.

In the next two symbol transmission groups, only the third link 16 has set flags, so the third link 16 transmits the next two symbols, “e” and “_”, in sequence. Transmitter 10 has now exhausted all of the symbol transmission groups, so transmitter 10 goes back to the first symbol transmission group in Table 3. Here, all the flags are set, indicating that all of the links 16 are ready to accept new symbols, so symbols “t”, “h”, “a” and “t” are transmitted via the first, second, third and fourth links 16, respectively.

Continuing in this fashion, all forty characters of the message are transmitted, making full use of the combined symbol transmission rates of the four links 16, in this case ten times the link symbol transmission rate of the first link 16. Had only the third link 16, the fastest of the available links 16, been used, the transmission rate would have only been five times the link symbol transmission rate of the first link 16.

Note that data links 16 are assigned traffic in proportion to their ability to transmit traffic.

Reception of the message follows a similar pattern. Referring to the lower portion of FIG. 2, inverse multiplex receiver 12 makes use of Table 3. It will be appreciated that there are many ways in which receiver 12 can obtain Table 3, all of which are within the scope of the present invention. In this preferred embodiment of the present invention, receiver 12 derives Table 3 by making use of Table 1 and Table 2. It will be appreciated that there are many ways in which receiver 12 can obtain Table 1 and Table 2, all of which are within the scope of the present invention. In this exemplary preferred embodiment of the present invention, transmitter 10 sends Table 1 and Table 2 to receiver 12 during link-startup negotiations. In an alternative embodiment of the present invention, transmitter 10 sends Table 3 directly to receiver 12 during link-startup negotiations.

Reference to Table 3 shows that, in the first symbol transmission group, a symbol is expected from every receiver input port 22. Inverse multiplex receiver 12 traverses receiver input ports 22 in order, waiting for a symbol from each respective receiver input port 22. Note that, due to latencies in the individual links 16, receiver 12 may have to wait for a particular receiver input port 22 to present a symbol, and, in the meantime, symbols arriving via other links 16 must be buffered in a first-in-first-out fashion. Preferably, symbols are buffered by receiver input ports 22. Alternatively, buffering takes place in other parts of the system, as is known in the art. For example, in this case, assuming that delays in links 16 are insignificant, all of the other receiver input ports 22 will have one or more symbols waiting in buffers by the time the “A” finally arrives at the first receiver input port 22. Once the “A” arrives at the first receiver input port 22, receiver 12 reads the “A” from the first receiver input port 22, and then immediately proceeds to read the buffered symbols from the other receiver input ports 22 in the order prescribed by Table 3. The symbol “A” is taken from the first receiver input port 22, the symbol “_” is taken from the second receiver input port 22, the symbol “m” is taken from the third receiver input port 22, and the symbol “e” is taken from the fourth receiver input port 22, completing reception of the first symbol transmission group. In the next symbol transmission group, only the third flag, that of the high-speed third link 16, is set, so the symbol “s” is taken from the third receiver input port 22, and receiver 12 does not wait for symbols from the other receiver input ports 22 during this symbol transmission group. In the third transmission group, receiver 12 finds the second, third and fourth flags set, so receiver 12 waits for symbols from the second, third and fourth receiver input ports 22, in that order, so that the symbols “s”, “a” and “g” are received. Note that a new symbol is not expected from the first receiver input port 22 in this symbol transmission group.

In the next two symbol transmission groups, only the third link 16 has set flags, so receiver 12 receives two symbols, “e” and “_” in sequence, from the third receiver input port 22, but does not receive symbols from the other receiver input ports 22. Receiver 12 has now exhausted all of the symbol transmission groups, so receiver 12 goes back to the first symbol transmission group in Table 3. Here, all flags are set, indicating that receiver 12 should wait for symbols from all receiver input ports 22, in sequence, so the symbols “t”, “h”, “a” and “t” are received from the first, second, third and fourth receiver input ports 22, respectively.

Continuing in this fashion, all forty characters of the message are received in the exact order they were presented to inverse multiplex transmitter 10.

The possibility exists that one or more of the communication links 16 in an inverse multiplex system will fail to transmit symbols. Preferably, the inverse multiplex system protects the integrity of the data the system transmits by the use of well-known methods, such as the use of checksums or cyclic redundancy coding. If any individual communication link 16 proves troublesome, that link 16 preferably is removed from Table 2, and, if used, Table 3, of transmitter 10 and receiver 12. In this manner, the inverse multiplex system of the present invention continues to operate, although at a lower aggregate symbol transmission rate.

While the invention has been described as having links that do not all have the same link symbol transmission rate, it will be appreciated that the invention is also applicable to situations where all links have the same link symbol transmission rate.

While the invention has been described with respect to a limited number of embodiments, it will be appreciated that many variations, modifications and other applications of the invention may be made.

What is claimed is

1. A system for transmitting symbols via a plurality of communication links, each communication link having a respective link symbol transmission rate, the system comprising:
(a) a transmitter including
(i) an input port operative to receive symbols;
(ii) a plurality of output ports operative to transmit said symbols via respective communication links; and
(iii) a mechanism for indicating when to transmit symbols for each respective link symbol transmission rate.

2. The system of claim 1, wherein said mechanism includes a table of rows of flags indicating when to transmit symbols, each said row corresponding to one of said link symbol transmission rates.

3. The system of claim 2, wherein a respective number of said flags in each said row are set, said number chosen such that symbols are transmitted via corresponding said output ports at a rate at most equal to the corresponding link symbol transmission rate.

4. The system of claim 2, wherein a respective number of said flags in each said row are set, said number chosen such that symbols are transmitted via corresponding said output ports at a rate substantially proportional to the corresponding link symbol transmission rate.

5. The system of claim 1, wherein said transmitter further includes
(iv) at least one buffer operative to store, in a first-in-first-out fashion, symbols waiting to be transmitted via the communication links.

6. The system of claim 1, further comprising:
(b) a receiver, for receiving said symbols via the communication links, said receiver including a mechanism for providing indications of when symbols are scheduled to be transmitted for each respective link symbol transmission rate.

7. The system of claim 6, wherein said receiver further includes at least one buffer operative to store, in a first-in-first-out fashion, symbols arriving via the communication links.

8. A method for transmitting symbols via a plurality of communication links, each communication link having a respective link symbol transmission rate, the method comprising the steps of
(a) indicating when to transmit symbols for each respective link symbol transmission rate; and
(b) for each symbol, selecting a communication link to transmit the symbol, according to said indications of when to transmit symbols.

9. The method of claim 8, wherein said indicating of when to transmit symbols includes providing a table of rows of flags indicating when to transmit symbols, each said row corresponding to one of the link symbol transmission rates.
